(19) United States
(12) Patent Application Publication
(10) Pub. No.: US 2026/0252920 A1
(43) Pub. Date: Aug. 27, 2026

(54) Dynamic Judgment Placement, Authority Reallocation, and Conditional Resume for Deferred Evaluation in Exploratory Information Processing

(71) Applicant: KOJI MOCHIZUKI, Suita (JP)

(72) Inventor: KOJI MOCHIZUKI, Suita (JP)

(21) Appl. No.: 19/647,878

(22) Filed: Apr. 15, 2026

(30) Foreign Application Priority Data
Feb. 5, 2026 (JP) 2026-018084
Feb. 5, 2026 (JP) 2026-018086
Apr. 6, 2026 (JP) 2026-062463
Apr. 6, 2026 (JP) 2026-062464

(51) Int. Cl. G06N 5/04

(52) U.S. Cl. CPC G06N 5/04

(57) ABSTRACT

A candidate generated in exploratory information processing is subjected to deferred irreversible evaluation based on at least one of evaluation incompleteness, uncertainty, verification infeasibility, resource insufficiency, time constraint, safety condition, explanation insufficiency, external dependency, or unavailability of a review subject. The candidate is registered in a deferred-candidate set distinct from a committed-candidate set and is associated with an exploration subject, a judgment subject, an authority subject, and a responsibility subject. Role relationships and authority/responsibility allocation are dynamically reconfigured, and at least one of an exploration mode, a holding mode, a safety-side mode, or a reevaluation mode is controlled accordingly. When a reevaluation condition or a resume condition, and at least part of an irreversible-judgment permission condition and a responsibility-fixation condition, are satisfied, reevaluation, partial continuation, or conditional resume is executed, and irreversible evaluation is selectively executed thereafter.

### CROSS-REFERENCE TO RELATED APPLICATIONS

This application claims priority to Japanese Patent Application Nos. 2026-062463, 2026-062464, 2026-018086, and 2026-018084.

The entire contents of the above applications are incorporated herein by reference to the extent permitted by applicable law.

### FIELD OF THE INVENTION

The present invention relates to deferred-evaluation control in exploratory information processing, and more particularly to dynamic judgment placement, authority reallocation, responsibility-fixation-condition management, and conditional reevaluation or conditional resume for deferred candidates.

The present invention is applicable to information processing systems including, for example, artificial intelligence, semiconductor design, ADAS or autonomous-driving support, robotics, cybersecurity operations, legal or compliance review, medical decision support, logistics optimization, educational evaluation, public-sector review, scientific measurement, quantum evaluation, materials exploration, and drug discovery.

### BACKGROUND OF THE INVENTION

In exploratory, inferential, design, verification, evaluation, and decision-support information processing systems, multiple candidates may be generated during processing. In some cases, it may be desirable to immediately determine whether such candidates are to be adopted, rejected, approved, executed, or excluded. In practice, however, there are many situations in which immediate irreversible evaluation is inappropriate due to evaluation incompleteness, uncertainty, external dependency, explanation insufficiency, unconfirmed safety conditions, unavailability of a review subject, or insufficient resources.

Conventional information processing systems often rely either on immediate acceptance/rejection determination or on simple queue-based postponement for later review. In the former case, irreversible judgment may be fixed too early, causing candidates that could later become useful to be excluded prematurely and reducing exploratory optionality. In the latter case, the timing of evaluation may be delayed, but the system may still fail to jointly control which subject performs reevaluation, approval, responsibility acceptance, or resume authorization and under what conditions.

Some systems separately introduce human review, approval workflows, audit logging, checkpoint storage, restart control, or state restoration. In many cases, however, such approaches do not treat, within a single overarching architecture, how to retain a deferred candidate, how to prioritize such candidates, how to shift judgment to another subject, under what conditions to fix responsibility, and what range of state should be retained or restored for later execution.

Accordingly, there is a need for a technique that, in exploratory information processing, can integrally control when to defer irreversible evaluation of a candidate, when to resume candidate processing, to which subjects judgment should be assigned, under what conditions responsibility should be fixed, and what range of state should be retained or restored.

### SUMMARY OF THE INVENTION

An object of the present invention is to provide a technique capable of integrally controlling, in exploratory information processing, the timing of downstream judgment placement, judgment destination, authority allocation, responsibility-fixation conditions, and conditional resume while preserving exploratory optionality without prematurely fixing irreversible evaluation of a candidate.

A candidate generated in an exploratory process is received, and it is determined, based on at least one of evaluation incompleteness, uncertainty, verification infeasibility, resource insufficiency, time constraint, safety condition, explanation insufficiency, external dependency, or unavailability of a review subject, that irreversible evaluation of the candidate is to be deferred.

The candidate is registered in a deferred-candidate set distinct from a committed-candidate set, and at least part of provisional evaluation information, uncertainty information, deferral reason information, resource-state information, deadline information, dependency information, review-subject availability information, responsibility-allocation information, irreversible-judgment permission information, and responsibility-fixation-condition information is associated with the candidate.

The candidate is further associated with an exploration subject, a judgment subject, at least one authority subject, and at least one responsibility subject. The authority subject may be used for at least one of review, reevaluation, approval, execution permission, resume authorization, mode-switch authorization, or irreversible-evaluation authorization. The responsibility subject may be used for at least one of responsibility acceptance, accountability attribution, approval responsibility, supervisory responsibility, or responsibility fixation.

Role relationships among the exploration subject, the judgment subject, the authority subject, and the responsibility subject are dynamically reallocated according to at least one of the deferral-related information, a system condition, a risk condition, an authority-allocation condition, a trigger condition, or a responsibility-fixation condition. At least one of an exploration mode, a holding mode, a safety-side mode, or a reevaluation mode is controlled according to the reallocated relationship.

When a reevaluation condition or a resume condition is satisfied, and at least part of an irreversible-judgment permission condition and at least part of a responsibility-fixation condition are satisfied, at least one of reevaluation, partial continuation, or conditional resume is executed for the deferred candidate, and irreversible evaluation is selectively executed thereafter based on a result of the reevaluation, partial continuation, or conditional resume.

In this configuration, deferral of irreversible evaluation does not determine rejection, disqualification, or final exclusion of the candidate. Thus, exploratory optionality can be preserved while additional candidates continue to be generated or refined.

### BRIEF DESCRIPTION OF THE DRAWINGS

FIG. 1 is an overall functional block diagram of an umbrella architecture including dynamic judgment placement, authority reallocation, responsibility-fixation-condition management, conditional reevaluation, partial continuation, conditional resume, and selective irreversible evaluation for deferred candidates according to one embodiment of the present invention.

FIG. 2 is an explanatory diagram of a control-plane branch including reevaluation-priority calculation, escalation determination, reallocation of an authority subject or a responsibility subject, role reconfiguration, and mode switching for deferred candidates according to one embodiment of the present invention.

FIG. 3 is an explanatory diagram of a state-plane branch including dependency analysis, minimal or quasi-minimal state-set extraction, association and retention of acceptance conditions, invalidation conditions, and reevaluation-trigger conditions, partial restoration, and conditional resume according to one embodiment of the present invention.

FIG. 4 is an integrated processing flow diagram including candidate generation, deferral determination, subject association, role reallocation, mode control, reevaluation-condition determination, responsibility-fixation-condition determination, conditional reevaluation, partial continuation, or conditional resume, followed by selective irreversible evaluation or continuation/end according to one embodiment of the present invention.

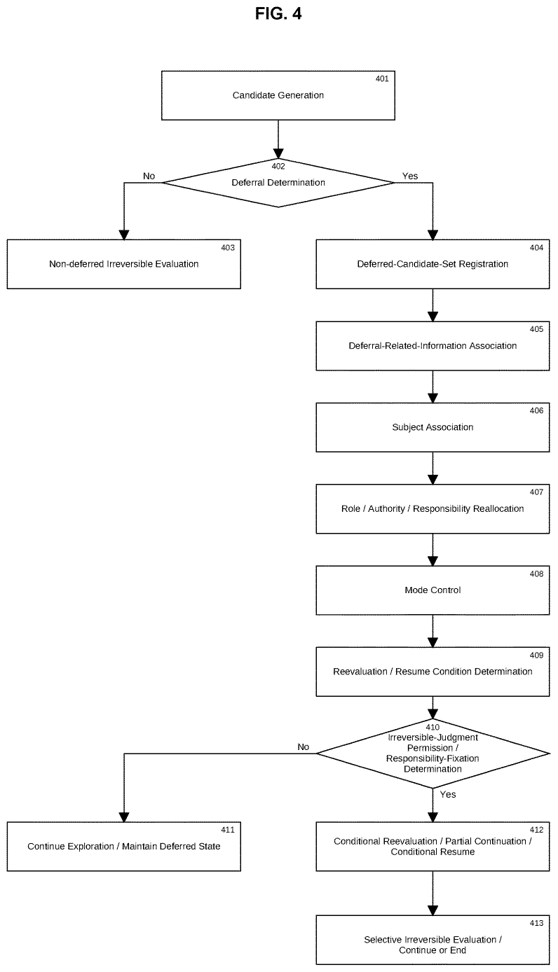

### DETAILED DESCRIPTION OF THE INVENTION

### 1. System Overview

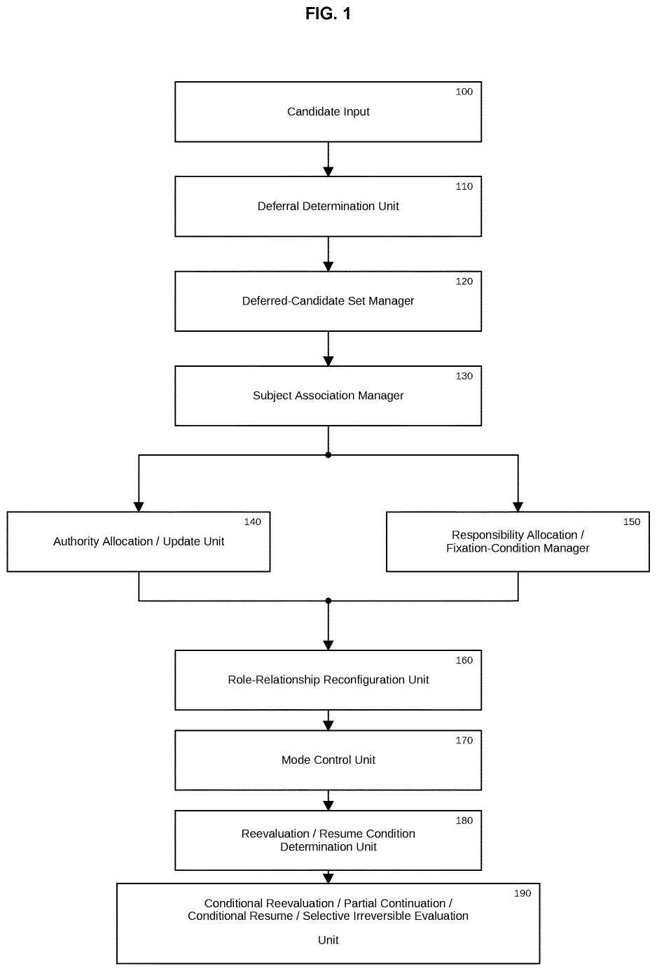

Referring to FIG. 1, an exemplary system according to the present invention includes a candidate input unit 100, a deferral determination unit 110, a deferred-candidate-set management unit 120, a subject-association management unit 130, an authority-allocation/update unit 140, a responsibility-allocation/responsibility-fixation-condition management unit 150, a role-relationship reconfiguration unit 160, a mode control unit 170, a reevaluation/resume-condition determination unit 180, and a conditional reevaluation/partial continuation/conditional resume/selective irreversible evaluation unit 190.

The candidate input unit 100 receives a candidate generated in an exploratory process.

The deferral determination unit 110 determines whether irreversible evaluation of the candidate is to be deferred or whether the candidate is to be subjected to non-deferred irreversible evaluation.

The deferred-candidate-set management unit 120 registers and maintains a candidate determined to be deferred in a deferred-candidate set distinct from a committed-candidate set.

The subject-association management unit 130 associates, for each deferred candidate, an exploration subject, a judgment subject, an authority subject, and a responsibility subject.

The authority-allocation/update unit 140 allocates or updates authority relating to at least one of review, reevaluation, approval, execution permission, resume authorization, mode-switch authorization, or irreversible-evaluation authorization to the authority subject.

The responsibility-allocation/responsibility-fixation-condition management unit 150 manages, for the deferred candidate, at least one of responsibility acceptance, accountability attribution, approval responsibility, supervisory responsibility, or responsibility fixation in association with the responsibility subject.

The role-relationship reconfiguration unit 160 dynamically reallocates role relationships among the exploration subject, the judgment subject, the authority subject, and the responsibility subject.

The mode control unit 170 controls at least one of an exploration mode, a holding mode, a safety-side mode, or a reevaluation mode.

The reevaluation/resume-condition determination unit 180 determines whether a reevaluation condition or a resume condition has been satisfied for a deferred candidate.

The conditional reevaluation/partial continuation/conditional resume/selective irreversible evaluation unit 190 executes, when the reevaluation condition or the resume condition is satisfied and at least part of an irreversible-judgment permission condition and at least part of a responsibility-fixation condition are satisfied, at least one of conditional reevaluation, partial continuation, or conditional resume for the deferred candidate, and selectively executes irreversible evaluation thereafter based on a result of the conditional reevaluation, partial continuation, or conditional resume.

In the present system, deferral of irreversible evaluation does not determine rejection, disqualification, or final exclusion of the candidate.

### 2. Definitions

“Deferred candidate” means a candidate for which irreversible evaluation is not immediately executed and which is instead retained for downstream reevaluation, approval, resume, or irreversible evaluation.

“Deferred-candidate set” means a set or storage structure that maintains deferred candidates separately from a committed-candidate set.

“Committed-candidate set” means a set or storage structure that maintains candidates to which irreversible judgment has already been applied.

“Irreversible evaluation” means an evaluation or judgment that fixes at least part of a downstream state of a candidate, including adoption, rejection, approval, exclusion, execution transition, responsibility fixation, or analogous determinations.

“Deferral” and “defer” mean sending irreversible evaluation of a candidate to a later stage and do not determine rejection, disqualification, final exclusion, or inferiority of the candidate.

“Exploration subject” means a subject that performs at least one of candidate generation, candidate expansion, candidate refinement, or exploration-space expansion.

“Judgment subject” means a subject that determines when irreversible evaluation of a candidate is to be performed, whether irreversible evaluation should be performed, or under what conditions irreversible evaluation is to be permitted.

“Authority subject” means a subject assigned authority to perform at least one of review, reevaluation, approval, execution permission, resume authorization, mode-switch authorization, or irreversible-evaluation authorization.

“Authority-allocation condition” means a condition for granting, modifying, limiting, canceling, or reallocating authority to an authority subject.

“Responsibility subject” means a subject that bears at least part of responsibility, accountability, supervisory responsibility, approval responsibility, legal responsibility, or operational consequence-acceptance responsibility with respect to reevaluation, approval, execution, resume, or irreversible evaluation of a deferred candidate.

“Reevaluation condition” means a condition that permits initiation of reevaluation of a deferred candidate.

“Resume condition” means a condition that permits initiation of exploration restart, process continuation, partial continuation, or selective resume for a deferred candidate.

“Irreversible-judgment permission condition” means a condition that permits application of irreversible evaluation or other fixed-effect judgment to a candidate.

“Responsibility-fixation condition” means a condition that permits fixation of all or part of responsibility to a responsibility subject.

“Conditional resume” means initiating reevaluation, partial continuation, exploration restart, or irreversible evaluation when at least part of a reevaluation condition, a resume condition, an irreversible-judgment permission condition, or a responsibility-fixation condition is satisfied.

“Control-plane branch” means a branch including at least one of reevaluation-priority calculation, reevaluation-order determination, escalation determination, reallocation of an authority subject or a responsibility subject, role reconfiguration, or mode switching.

“State-plane branch” means a branch including at least one of dependency analysis, minimal or quasi-minimal state-set extraction, retention of acceptance conditions, invalidation conditions, or reevaluation-trigger conditions, partial restoration, or selective resume.

### 3. Integrated Processing Flow

At candidate generation 401, a candidate is generated from an exploratory process.

At deferral determination 402, it is determined whether irreversible evaluation of the candidate is to be deferred.

If irreversible evaluation is not to be deferred, the flow proceeds to Non-deferred Irreversible Evaluation 403.

If irreversible evaluation is to be deferred, the flow proceeds to deferred-candidate-set registration 404.

At deferral-related-information association 405, deferral-related information is associated with the deferred candidate.

At subject association 406, the deferred candidate is associated with an exploration subject, a judgment subject, at least one authority subject, and at least one responsibility subject.

At role/authority/responsibility reallocation 407, role relationships, authority allocation, and responsibility allocation are dynamically reconfigured.

At mode control 408, at least one of an exploration mode, a holding mode, a safety-side mode, or a reevaluation mode is controlled.

At reevaluation-condition or resume-condition determination 409, it is determined whether conditions have been satisfied for reevaluation or resume of the deferred candidate.

At irreversible-judgment-permission/responsibility-fixation determination 410, it is determined whether conditions permitting irreversible judgment and conditions permitting fixation of responsibility have been satisfied.

If the reevaluation condition or resume condition is not satisfied, or if the irreversible-judgment permission condition or the responsibility-fixation condition is not satisfied, the flow proceeds to continue exploration or maintain deferred state 411.

If the reevaluation condition or the resume condition is satisfied, and at least part of the irreversible-judgment permission condition and at least part of the responsibility-fixation condition are satisfied, the flow proceeds to conditional reevaluation/partial continuation/conditional resume 412.

At stage 412, the system performs at least one of conditional reevaluation, partial continuation, or conditional resume for the deferred candidate while maintaining association between the deferred candidate and the deferral-related information.

Thereafter, the flow proceeds to selective irreversible evaluation or continue/end 413. At stage 413, the system selectively performs irreversible evaluation when the result of stage 412 and the relevant conditions support such irreversible evaluation, and otherwise continues candidate processing or ends the current candidate-handling cycle without treating the original deferral as rejection, disqualification, or final exclusion.

### 4. Control-Plane Branch

A control-plane branch according to the present invention controls, for each deferred candidate, which candidate is to be processed, in what order, by which subject, and under what authority and responsibility allocation.

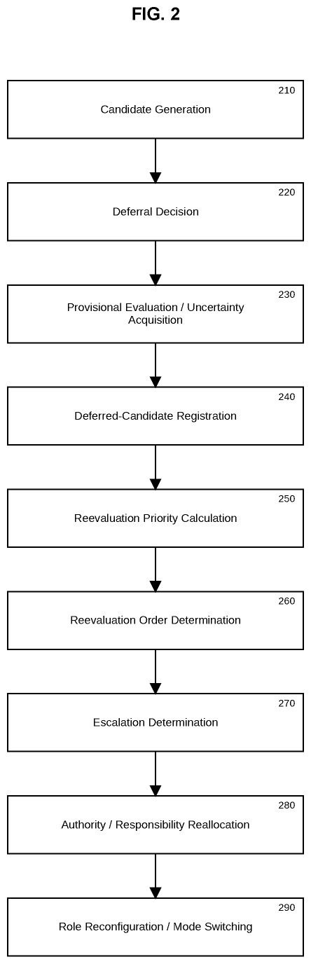

Referring to FIG. 2, after candidate generation 210, a deferral decision 220 is performed.

For a candidate determined to be deferred, provisional evaluation/uncertainty acquisition 230 is performed.

The candidate is then registered in a deferred-candidate set by deferred-candidate registration 240.

Reevaluation-priority calculation 250 calculates a reevaluation priority for each deferred candidate.

Reevaluation-order determination 260 determines a reevaluation order for a plurality of deferred candidates based on the reevaluation priority.

Escalation determination 270 determines whether at least some of the deferred candidates should be escalated.

Authority/responsibility reallocation 280 reallocates, for each deferred candidate, an authority subject and a responsibility subject.

Role reconfiguration/mode switching 290 updates role relationships among the exploration subject, the judgment subject, the authority subject, and the responsibility subject and switches processing modes.

### 5. State-Plane Branch

A state-plane branch according to the present invention controls what state is to be retained for a deferred candidate, what conditions are to be associated with that retained state, to what extent the state is to be restored, and how reevaluation or resume is to be performed.

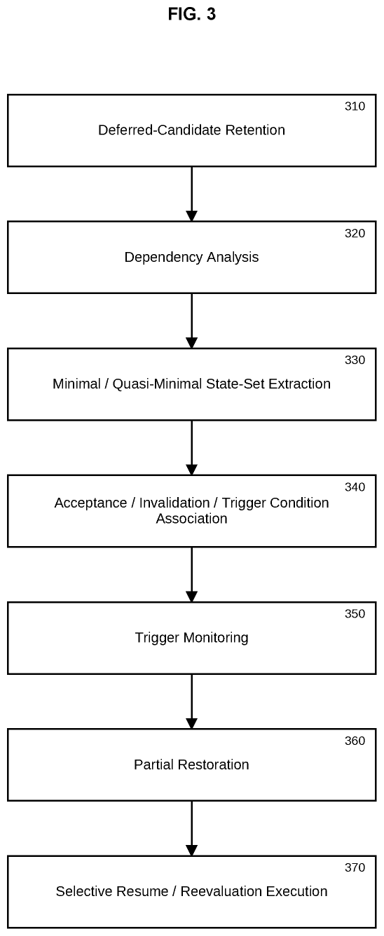

Referring to FIG. 3, the state-plane branch may include deferred-candidate retention 310, dependency analysis 320, minimal or quasi-minimal state-set extraction 330, retention of acceptance conditions, invalidation conditions, and trigger conditions 340, trigger monitoring 350, partial restoration 360, and selective resume/reevaluation execution 370.

### 6. Conceptual Relationship and Branch Structure

The present invention is organized around an umbrella concept of judgment-placement reconfiguration for deferred candidates.

As used in this specification, the umbrella concept does not imply a legal parent-child relationship among applications. Rather, it expresses a technical inclusion relationship and a branch structure.

In one branch, the present invention may provide an exploration-continuity branch in which a deferred candidate is retained without immediately performing irreversible evaluation.

In another branch, the present invention may provide an operational-governance branch including priority control, escalation determination, reallocation of an authority subject or a responsibility subject, role reconfiguration, accountability handling, audit handling, and mode switching.

In a further branch, the present invention may provide a resume-control branch including dependency analysis, minimal or quasi-minimal state-set extraction, retention of acceptance conditions, retention of invalidation conditions, retention of reevaluation-trigger conditions, partial restoration, and selective resume.

The exploration-continuity branch, the operational-governance branch, and the resume-control branch may be implemented independently or in combination.

### 11. Primary Examples

11.1 AI-assisted exploration or generative-AI workflow
11.2 Semiconductor design exploration
11.3 ADAS or autonomous-driving candidate evaluation
11.4 Robotics task or motion planning

### 12. Supplementary Examples

12.1 Cybersecurity operations
12.2 Legal or compliance review
12.3 Medical decision support
12.4 Logistics or warehouse optimization

### 13. Generalized Examples

13.1 Finance review or fraud detection
13.2 Educational evaluation
13.3 Public-sector review or adjudicative support
13.4 Scientific measurement, quantum evaluation, or physics simulation
13.5 Materials exploration or drug discovery

1. A computer-implemented method for deferred evaluation in exploratory information processing, the method comprising: receiving, by one or more processors, a candidate generated in an exploratory process; determining, by the one or more processors, that an irreversible evaluation of the candidate is to be deferred based on at least one of evaluation incompleteness, uncertainty, verification infeasibility, resource insufficiency, time constraint, safety condition, explanation insufficiency, external dependency, or unavailability of a review subject; registering, by the one or more processors, the candidate in a deferred-candidate set distinct from a committed-candidate set, together with deferral-related information including one or more of provisional evaluation information, uncertainty information, deferral reason information, resource-state information, deadline information, dependency information, review-subject availability information, responsibility-allocation information, irreversible-judgment permission information, or responsibility-fixation-condition information; associating, by the one or more processors, the deferred candidate with an exploration subject, a judgment subject, at least one authority subject, and at least one responsibility subject, wherein the at least one authority subject and the at least one responsibility subject are independently assignable and need not be identical; assigning or updating, by the one or more processors, the at least one authority subject for at least one of review, reevaluation, approval, execution permission, resume authorization, mode-switch authorization, or irreversible-evaluation authorization; assigning or updating, by the one or more processors, the at least one responsibility subject for at least one of responsibility acceptance, accountability attribution, approval responsibility, supervisory responsibility, or responsibility fixation associated with the deferred candidate; dynamically reallocating, by the one or more processors, a role relationship among the exploration subject, the judgment subject, the at least one authority subject, and the at least one responsibility subject according to at least one of the deferral-related information, a system condition, a risk condition, an authority-allocation condition, a trigger condition, or the responsibility-fixation-condition information, while the deferred candidate remains in the deferred-candidate set; controlling, by the one or more processors, at least one processing mode selected from an exploration mode, a holding mode, a safety-side mode, or a reevaluation mode according to the dynamically reallocated role relationship; and when a reevaluation condition or a resume condition is satisfied, and when at least part of an irreversible-judgment permission condition and at least part of a responsibility-fixation condition are satisfied, causing, by the one or more processors, reevaluation, partial continuation, or conditional resume of the deferred candidate while maintaining association between the deferred candidate and the deferral-related information, and thereafter causing irreversible evaluation of the deferred candidate based on a result of the reevaluation, partial continuation, or conditional resume, wherein deferral of the irreversible evaluation does not determine rejection, disqualification, or final exclusion of the candidate before satisfaction of the reevaluation condition or the resume condition, thereby preserving exploratory optionality during the exploratory process.

2. A system for deferred evaluation in exploratory information processing, the system comprising: one or more processors; and a memory storing instructions that, when executed by the one or more processors, cause the system to: receive a candidate generated in an exploratory process; determine whether irreversible evaluation of the candidate is to be deferred; register the candidate in a deferred-candidate set distinct from a committed-candidate set together with deferral-related information including one or more of provisional evaluation information, uncertainty information, deferral reason information, dependency information, review-subject availability information, responsibility-allocation information, irreversible-judgment permission information, or responsibility-fixation-condition information; associate the candidate with an exploration subject, a judgment subject, at least one authority subject, and at least one responsibility subject; assign or update the at least one authority subject for at least one of review, reevaluation, approval, execution permission, resume authorization, mode-switch authorization, or irreversible-evaluation authorization; assign or update the at least one responsibility subject for at least one of responsibility acceptance, accountability attribution, approval responsibility, supervisory responsibility, or responsibility fixation associated with the candidate; dynamically reallocate a role relationship among the exploration subject, the judgment subject, the at least one authority subject, and the at least one responsibility subject; control a processing mode based on the dynamically reallocated role relationship; and upon satisfaction of a reevaluation condition or a resume condition, and upon satisfaction of at least part of an irreversible-judgment permission condition and at least part of a responsibility-fixation condition, initiate at least one of reevaluation, partial continuation, or conditional resume of the candidate while maintaining association between the candidate and the deferral-related information, and thereafter selectively initiate irreversible evaluation of the candidate based on a result of the reevaluation, partial continuation, or conditional resume, wherein deferral of the irreversible evaluation does not determine rejection, disqualification, or final exclusion of the candidate before satisfaction of the reevaluation condition or the resume condition.

3. A non-transitory computer-readable medium storing instructions that, when executed by one or more processors, cause the one or more processors to perform operations comprising: receiving a candidate generated in an exploratory process; determining that irreversible evaluation of the candidate is to be deferred; registering the candidate in a deferred-candidate set distinct from a committed-candidate set together with deferral-related information; associating the candidate with an exploration subject, a judgment subject, at least one authority subject, and at least one responsibility subject; assigning or updating the at least one authority subject; assigning or updating the at least one responsibility subject; dynamically reallocating a role relationship among the exploration subject, the judgment subject, the at least one authority subject, and the at least one responsibility subject; controlling a processing mode based on the dynamically reallocated role relationship; and when a reevaluation condition or a resume condition is satisfied, and when at least part of an irreversible-judgment permission condition and at least part of a responsibility-fixation condition are satisfied, causing reevaluation, partial continuation, or conditional resume of the candidate while maintaining association between the candidate and the deferral-related information, and thereafter selectively causing irreversible evaluation of the candidate based on a result of the reevaluation, partial continuation, or conditional resume, wherein the instructions cause preservation of exploratory optionality by withholding the irreversible evaluation without determining rejection, disqualification, or final exclusion of the candidate before satisfaction of the reevaluation condition or the resume condition.

4. The method of claim 1, wherein dynamically reallocating the role relationship includes reassigning at least one of candidate generation, verification, explanation generation, approval routing, execution authorization, or reevaluation authorization among a plurality of subjects.

5. The method of claim 1, further comprising calculating, for each deferred candidate, a reevaluation priority based on at least a plurality of factors selected from provisional evaluation information, uncertainty information, deferral reason information, evaluation cost information, deadline information, review-subject availability information, resource-state information, responsibility-allocation information, an authority-allocation condition, or a responsibility-fixation condition, and determining a reevaluation order for a plurality of deferred candidates based on the reevaluation priority.

6. The method of claim 1, wherein the at least one authority subject comprises at least one of a human participant, an organizational role, a software agent, a service component, an external verification subject, or a policy-defined subject.

7. The method of claim 1, wherein the at least one responsibility subject comprises at least one of a human participant, a supervisory role, an approval role, a compliance role, a safety role, or an organization-designated responsibility holder.

8. The method of claim 1, wherein the reevaluation condition or the resume condition includes at least one of resource recovery, acquisition of additional data, acquisition of additional observation, receipt of an external verification result, availability of a review subject, update of a threshold condition, update of a policy condition, change in an environment state, satisfaction of at least part of the irreversible-judgment permission condition, or satisfaction of at least part of the responsibility-fixation condition.

9. The method of claim 1, wherein dynamically reallocating the role relationship includes escalating the deferred candidate to a human responsibility subject or a human authority subject when at least one of uncertainty, safety risk, legal impact, explanation insufficiency, or accountability requirement exceeds a threshold.

10. The method of claim 1, wherein deferral of the irreversible evaluation preserves the deferred candidate in the deferred-candidate set without determining inferiority, rejection, disqualification, or committed inferiority of the deferred candidate while the exploratory process continues to generate or refine one or more additional candidates.

11. The method of claim 1, wherein the dependency information includes at least one of a dependency graph, a boundary-state relation, an external-observation dependency, a model dependency, a verification-state dependency, or a context dependency associated with the deferred candidate.

12. The method of claim 1, wherein causing the conditional resume includes restoring less than an entirety of system state associated with the deferred candidate and resuming reevaluation or exploration based on the restored state.

13. The method of claim 12, wherein the restored state is based on a minimal or quasi-minimal state set associated with at least one of an acceptance condition, an invalidation condition, a trigger condition, or dependency information corresponding to the deferred candidate.

14. The method of claim 1, wherein controlling the at least one processing mode includes switching among the exploration mode, the holding mode, the safety-side mode, and the reevaluation mode according to at least one of the dynamically reallocated role relationship, the reevaluation priority, the authority-allocation condition, the responsibility-fixation condition, the reevaluation condition, or the resume condition.

15. The method of claim 1, wherein the exploratory process includes at least one of AI-assisted design exploration, semiconductor design exploration, ADAS or autonomous-driving candidate evaluation, or robotics task or motion planning.
